(19) United States
(12) Patent Application Publication
(10) Pub. No.: US 2007/0131469 A1
(43) Pub. Date: Jun. 14, 2007

(54) Power train mounting apparatus of vehicle

(76) Inventor: Hyo-Seok Kim, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/299,378

(22) Filed: Dec. 8, 2005

(51) Int. Cl. B60K 5/00

(52) U.S. Cl. 180/293

(57) ABSTRACT

A power train mounting apparatus for a vehicle is disclosed to improve the vehicle riding by properly restricting the displacement of the power train. The dynamic rigidity and vibration insulation in relation to an engine mount and transmission mount are also increased, thus improving the Noise, Vibration, and Harshness (NVH) function of the vehicle.

### FIELD OF THE INVENTION

The present invention relates to a mounting apparatus for a power train of a vehicle adapted to control the displacement of the power train and increase dynamic rigidity and vibration insulation of each mount, thereby improving a ride comfort and the Noise, Vibration, and Harshness (NVH) function of the vehicle.

### BACKGROUND OF THE INVENTION

A power train mounting apparatus that supports the power train and insulates noise and vibration thereof is generally formed by a principal axis of inertia of three to four support points or a center of gravity of three support points.

For light automobiles, the center of gravity or principal axis of inertia of three support points is typically used. However, as the center of gravity requires a sub-frame, crossmember, or center member, the principal axis of inertia of three support points has mainly been adopted in recent vehicles for reducing the weight and improving the rate of fuel consumption thereby.

The principal axis of inertia of three support points has two main mounts, such as an engine and transmission mounts, at the vehicle body. A third mount (roll mount or roll rod) is at the crossmember.

In case of the center of gravity of three support points, all mounts are located underneath the engine, and thus, it is difficult to restrict engine roll. Hence, the Noise, Vibration, and Harshness (NVH) function and vehicle ride are inferior to that of the principal axis of inertia of three support points.

However, a drawback of the principal axis of inertia of three support points is that one mount is conventionally a roll rod that controls the displacement of engine roll; therefore, a relatively large displacement of the engine occurs in the vertical direction thereof.

Accordingly, a liquid filled hydraulic mount is added either to the engine mount or transmission mount for preventing the deterioration of the vehicle ride.

The liquid filled hydraulic mount, however, is heavy in weight and high in manufacturing cost such that the price load could fall heavily on the drivers of light vehicles.

### SUMMARY OF THE INVENTION

Embodiments of the present invention help control the displacement of a power train and increase dynamic rigidity and vibration insulation of each mount, thereby improving the ride comfort and the Noise, Vibration, and Harshness (NVH) function of the vehicle.

A power train mounting apparatus of a vehicle according to one embodiment of the present invention includes an engine mount supportively connecting an engine and side member therebetween in an engine compartment. A transmission mount supportively connects a transmission and side member therebetween. A roll mount supportively connects a crossmember and the joint of the engine and transmission therebetween.

The engine mount is constituted by an upper and lower brackets, a bridge-type insulator contacting the lower bracket, and an inner pipe fixed to the insulator.

The transmission mount is constituted by an outer pipe, a bridge-type insulator contacting the outer pipe, and an inner pipe fixed to the insulator.

The roll mount is constituted by bushing-type mounts placed at both ends of the roll mount, and a roll rod that connects the bushing-type mounts therebetween.

### BRIEF DESCRIPTION OF THE DRAWINGS

For a better understanding of the nature and objects of the present invention, reference should be made to the following detailed description with the accompanying drawings, in which:

FIG. 1 a schematic view of a power train mounting apparatus according to an embodiment of the present invention;

FIGS. 2 to 3 illustrate an engine mount of FIG. 1;

FIGS. 4 to 5 illustrate a transmission mount of FIG. 1; and

FIG. 6 illustrates a rear roll mount of FIG. 1.

### DETAILED DESCRIPTION OF THE PREFERRED EMBODIMENTS

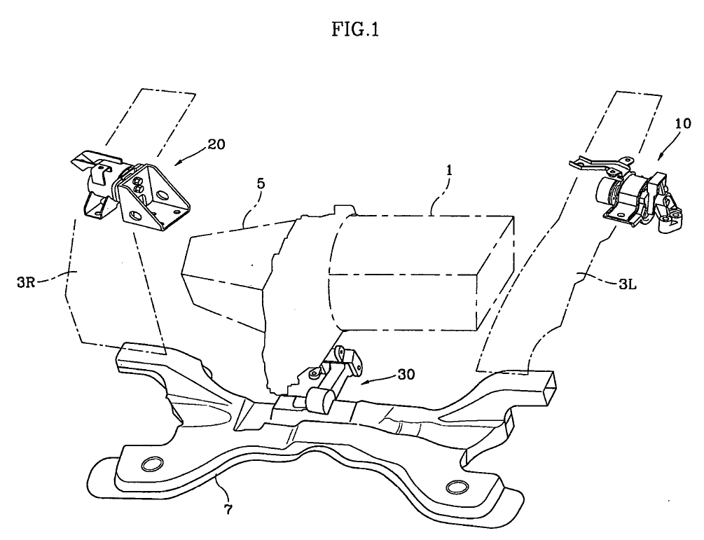

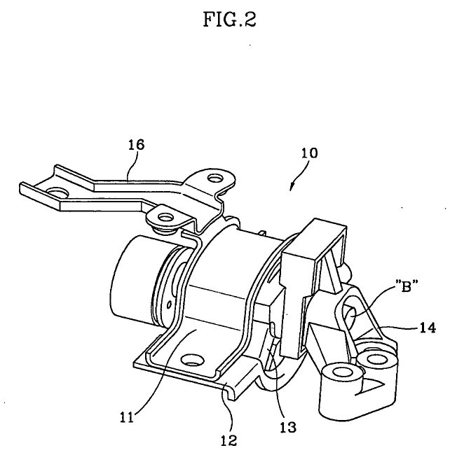

Referring to FIG. 1, a preferred embodiment of the present invention includes an engine 1 and transmission 5 that attach at three places to a left and right side members 3L and 3R of the vehicle body and a rear crossmember 7 in an engine compartment.

An engine mount 10 is located between engine 1 and left side member 3L, a transmission mount 20 is located between transmission 5 and right side member 3R, and a roll mount 30 is placed between rear crossmember 7 and the joint of engine 1 and transmission 5.

Engine mount 10, as shown in FIG. 2, is composed of an upper and lower brackets 11 and 12, bridge-type insulator 13, and support bracket assembly 14. Upper and lower brackets 11 and 12 couple to each other at both ends thereof, and bridge-type insulator 13 is fixed via vulcanization between upper and lower brackets 11 and 12. Support bracket assembly 14 attaches engine mount 10 to left side member 3L.

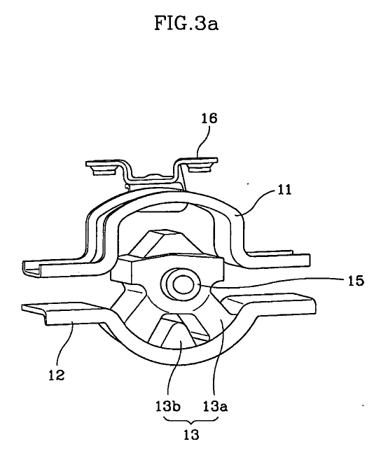

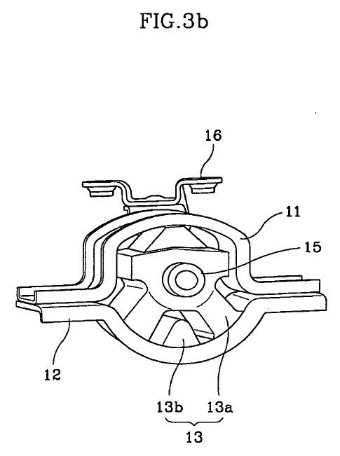

With reference to FIGS. 3a and 3b, the middle portions of upper and lower brackets 11 and 12 of engine mount 10 are convexly curved in flat sheet shapes. Each end of upper and lower brackets 11 and 12 are coupled to each other by means of spot welding.

The bottom of bridge-type insulator 13 fastens via vulcanization to lower bracket 12. The insulator is equipped at the center thereof with an inner pipe 15 via vulcanization. When upper bracket 11 couples to lower bracket 12, upper bracket 11 presses bridge-type insulator 13 for a pre-compression.

Support bracket assembly 14 coupled on left side member 3L supports engine mount 10 via a bolt (‘B’ in FIG. 2) penetrating inner pipe 15.

Bridge-type insulator 13 includes a primary damper 13a having inner pipe 15 at the center thereof and a plurality of split ends. Each end of primary damper 13a couples or contacts with upper and lower brackets 11 and 12. A supplementary damper 13b is distanced from primary damper 13a and secures at the bottom thereof to lower bracket 12.

An unexplained reference numeral 16 is an engine mounting bracket fixing engine mount 10 to engine 1.

As the pre-loaded insulator is fixed via vulcanization between the assembly of upper and lower brackets 11 and 12, the displacement of insulator 13 is minimized when the load is applied to engine mount 10 during engine operation.

Further, a gap between upper and lower brackets 11 and 12 and insulator 13 is minimized so that a large displacement of engine 1 can effectively be controlled and a comfortable vehicle ride is provided thereby.

Furthermore, engine mount 10 increases in damping value during a large displacement of engine 1 by the pre-compressed insulator; therefore, engine mount 10 may preferably substitute for an existed liquid filled engine mount.

Consequently, engine mount 10 improves the ride comfort by minimizing the displacement thereof in place of the costly liquid filled engine mount.

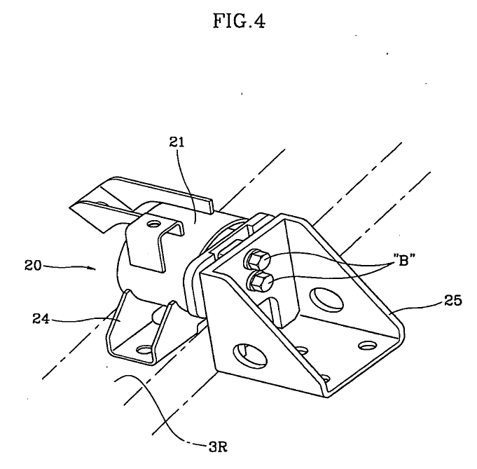

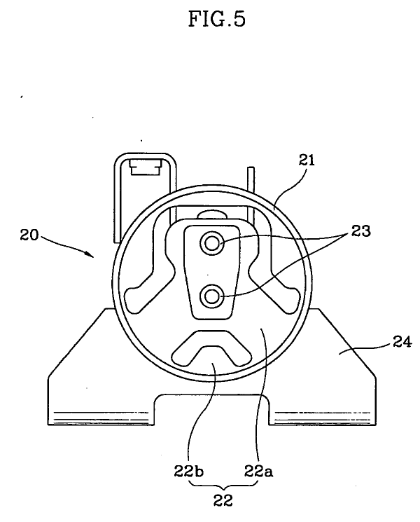

In reference to FIGS. 4 and 5, transmission mount 20 is constituted by an outer pipe 21, bridge-type insulator 22, and inner pipes 23. Outer pipe 21 is in the shape of a cylinder, bridge-type insulator 22 is situated via vulcanization in outer pipe 21, and inner pipes 23 are fixed via vulcanization at the center of the insulator in the lateral direction of the vehicle.

A side member mounting bracket 24 coupled at the outside of outer pipe 21 is disposed on right side member 3R in the engine compartment.

Bridge-type insulator 22 includes a primary damper 22a and supplementary damper 22b. Primary damper 22a has inner pipes 23 at the center thereof and a plurality of split ends. Each end of primary damper 22a couples or contacts outer pipe 21. Supplementary damper 22b is distanced from primary damper 22a and couples at the bottom thereof to outer pipe 21.

An unexplained reference numeral 25 is a transmission mounting bracket fixing transmission mount 20 to transmission 5.

Bolts (‘B’ in FIG. 4) passing through transmission mounting bracket 25 and inner pipes 23 of bridge-type insulator 22 support transmission mount 20 by connecting right side member 3R and transmission 5.

As for transmission mount 20, when the external force of compression is applied in the anteroposterior direction of bridge-type insulator 22 due to vehicle acceleration and engine roll, the force is absorbed by primary damper 22a of bridge-type insulator 22 to thereby reduce the noise upon acceleration by a gradual variation of the spring characteristic value.

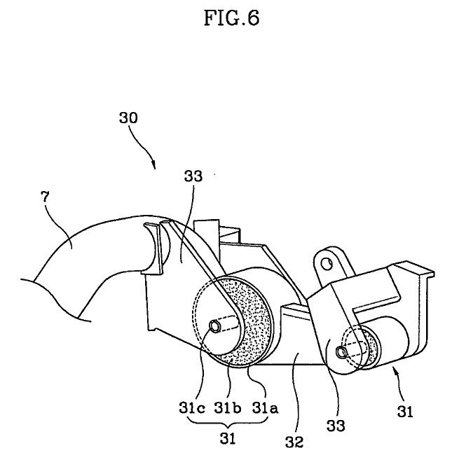

Referring now to FIG. 6, roll mount 30 connects rear crossmember 7 and the joint of engine 1 and transmission 5. Roll mount 30 includes bushing-type mounts 31 at both ends of roll mount 30, and a roll rod 32 connecting the bushing-type mounts therebetween.

Each bushing-type mount 31 has a cylindrical outer pipe 31a, and bushing-type insulators 31b fixed by means of vulcanization in the outer pipe. An inner pipe 31c is fixed at the center of the insulator by means of vulcanization in the lateral direction of the vehicle.

Unexplained reference numerals 33 are crossmember mounting brackets that fix bushing-type mounts 31 to rear crossmember 7 and the joint of engine 1 and transmission 5, respectively.

As for roll mount 30, when the external force of compression is applied in the anteroposterior direction of bushing-type mount 31 due to vehicle acceleration and engine roll, the force is absorbed by bushing-shaped insulator 31b installed sideways in the vehicle. Thus, the noise is lessened by a gradual variation of the spring characteristic value.

As apparent from the foregoing, there is an advantage in that a power train mounting apparatus according to the present invention fixes the engine and transmission to the side members and crossmember in the engine compartment by using a preloaded engine mount, transmission mount, and roll mount, thereby effectively coping with the large displacement of the engine during engine operation. The load displacement in the anteroposterior direction of the vehicle is also effectively dampened, thus improving the ride comfort.

Moreover, the liquid filled engine mount is substituted by an ordinary rubber engine mount that is preloaded or changed in installation direction thereof, contributing to a minimization of the manufacturing cost.

1. A power train mounting apparatus of a vehicle comprising:
an engine mount for supportively connecting an engine and a side member therebetween in an engine compartment; a transmission mount for supportively connecting a transmission and a side member therebetween; and a roll mount for supportively connecting a rear crossmember and a joint of said engine and said transmission therebetween,
wherein said engine mount includes:
an upper bracket and a lower bracket detachably coupled to each other; a bridge-type insulator contacting at a bottom thereof with said lower bracket; and an inner pipe fixed at a center of said insulator such that when said upper bracket is mounted to said lower bracket, said upper bracket precompresses said insulator;
wherein said transmission mount includes:
an outer pipe; a bridge-type insulator attaching to an inner periphery of said outer pipe; and inner pipes fixed at a center of said insulator in which said inner pipes are disposed in a lateral direction of said vehicle; and
wherein said roll mount includes:
bushing-type mounts placed at both ends of said roll mount; and a roll rod connecting said bushing-type mounts therebetween in which said bushing-type mountings are disposed in a lateral direction of said vehicle.

2. The mounting apparatus as defined in claim 1, wherein said bridge-type insulator of said engine mount comprises:
a primary damper having said inner pipe at a center thereof and a plurality of split ends, each end of said primary damper coupling or attaching to said upper and lower brackets; and
a supplementary damper that is distanced from said primary damper and secures at a bottom thereof to said lower bracket.

3. The mounting apparatus as defined in claim 1, wherein said bridge-type insulator of said transmission mount comprises:
a primary damper that has said inner pipes at a center thereof and a plurality of split ends, each end of said primary damper coupling or attaching to said outer pipe; and
a supplementary damper that is distanced from said primary damper and couples at a bottom thereof to said outer pipe.
